(19) United States
(12) Patent Application Publication
(10) Pub. No.: US 2026/0089076 A1
(43) Pub. Date: Mar. 26, 2026

(54) Selective Latency for Wireless Transmission in a Network

(71) Applicant: Apple Inc., CUPERTINO, CA (US)

(72) Inventors: Igor V RYSHAKOV, Mountain View, CA (US); Murat MESE, Atherton, CA (US); Robert D SILFVAST, Belmont, CA (US)

(21) Appl. No.: 18/897,259

(22) Filed: Sep. 26, 2024

(51) Int. Cl. H04L 43/0852; H04W 28/02; H04W 88/04

(52) U.S. Cl. CPC H04L 43/0852; H04W 28/0236; H04W 88/04

(57) ABSTRACT

A method for determining, by a first node of a network comprising a plurality of nodes, data with a latency requirement is to be sent to one or more receiver nodes in the network, selecting, from among a plurality of possible routes, a route for transmitting the data with the latency requirement to the one or more receiver nodes, wherein selecting the route comprises estimating a latency for one or more of the possible routes and using the estimated latency at least in part to select the route and transmitting the data with the latency requirement to the one or more receiver nodes using the selected route.

### BACKGROUND

A short-range communication protocol enables a short-range communication to be exchanged between two or more devices. There are many short-range communication protocols, including but not limited to various forms of Bluetooth and ultra-wideband (UWB). UWB is a radio technology that may use a very low energy level for short-range, high-bandwidth communications over a large portion of the radio spectrum. There are other low energy short-range technologies for use between two or more devices. The devices may be a single, integrated device such as a cellular phone, headphones, a headset, or an earpiece. Headphones, headsets or earpieces may include two audio components that have a wired or a wireless connection.

In certain situations, when there are two or more users each having a wireless communication device located within a short range, audio, haptic, or other generic data may be relayed from one user to another using UWB, Bluetooth, or other short-range wireless protocols. However, if the users are located in a noisy environment, e.g., many other transmitters or interference sources nearby, it may be difficult to quickly and efficiently relay the audio. In addition, because the short-range wireless protocols are generally low power, this may prevent efficient data flow. In addition, latency may be added because of retransmissions or as a result of multi-hop relays to avoid the weak radio links. These factors may result in a poor user experience when at least one of the wireless communication devices is unable to produce the proper output or where latency negatively affects the user experience. Thus, it would be beneficial to have an improved system where audio, haptic, or other generic data may be relayed from one user to another using short-range wireless protocols in a quick and efficient manner with acceptable levels of latency.

### SUMMARY

Some example embodiments are related to a method for determining, by a first node of a network comprising a plurality of nodes, data with a latency requirement is to be sent to one or more receiver nodes in the network, selecting, from among a plurality of possible routes, a route for transmitting the data with the latency requirement to the one or more receiver nodes, wherein selecting the route comprises estimating a latency for one or more of the possible routes and using the estimated latency at least in part to select the route and transmitting the data with the latency requirement to the one or more receiver nodes using the selected route.

Other example embodiments are related to an apparatus having processing circuitry configured to determine data with a latency requirement is to be sent to a receiver node in a network comprising a plurality of nodes, select a route for transmitting the data with the latency requirement to the receiver node from among a plurality of possible routes, wherein the route is selected, based at least on an estimated latency for one or more of the plurality of possible routes and prepare the data for transmission to the receiver node on the selected route.

### BRIEF DESCRIPTION OF THE DRAWINGS

FIG. 1 shows an arrangement of components utilizing short-range communication links according to various example embodiments.

FIG. 2 shows a device for establishing a short-range communication link according to various example embodiments.

FIG. 3 shows an alternative arrangement of components utilizing short-range communication links according to various example embodiments.

FIG. 4 shows an arrangement of components utilizing short-range communication links for retransmission or relay of data according to various example embodiments.

FIG. 5 shows an alternate arrangement of components utilizing short-range communication links for retransmission or relay according to various example embodiments.

FIG. 6 shows an arrangement of components utilizing short-range communication links that illustrates how latency requirements depend on distance according to various example embodiments.

FIG. 7 shows an example flow diagram of an example adaptive routing method for communicating data between nodes in a network that takes acoustic propagation assessments into account according to various example embodiments.

FIG. 8 shows an example payload for audio or voice data in a low latency network according to various example embodiments.

FIGS. 9A and 9B show an example selective relay map for a low latency network according to various example embodiments.

FIG. 10 shows an example node for communicating via short-range communication links with other nodes using an adaptive routing scheme according to various example embodiments.

### DETAILED DESCRIPTION

The example embodiments may be further understood with reference to the following description and the appended drawings, wherein like elements are referred to with the same reference numerals. The example embodiments relate to devices and methods of relaying audio, haptic, and other generic data between two or more wireless communication devices quickly and efficiently with acceptable levels of latency. In particular, devices and techniques for communicating data by wireless transceivers to convey data with a given latency requirement across a path from a source to a receiver may include retransmission of a device's own data and/or relaying another user's data (from a different device). The latency needed or desired for each path may be estimated and may depend on the data type and/or the occlusion and/or distance between each source and receiver. The latency of a data type may be gradually and smoothly adjusted when latency requirements change. The needed or desired latency may be used to select a subset of nodes to relay data for another node. Each of these aspects will be described in greater detail below.

The example embodiments are described herein with regard to establishing a short-range communication link (or connection) where the short-range communication link is a UWB link. However, the use of the UWB link is only an example and the UWB link may represent (or be replaced by) any short-range communication link.

The example embodiments are described with reference to example call flows. In the example call flows, various messages are described with reference to specific message names. It should be understood that these message names are only examples and messages that have other names (or no names at all) may be used to convey the information included in the various messages.

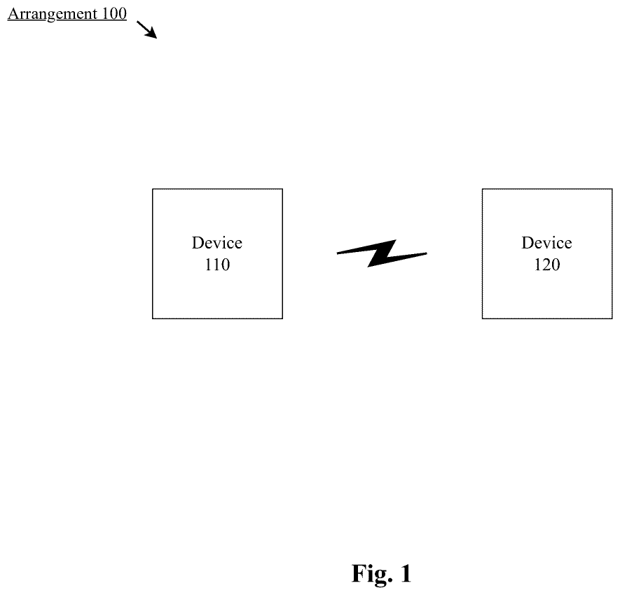

FIG. 1 shows an arrangement 100 of components utilizing short-range communication links according to various example embodiments. The arrangement 100 shows a first device 110 and a second device 120 that are both capable of establishing a short-range communication link, e.g., a UWB communication link. In this example, the devices 110 and 120 are shown as having a mutual relationship (e.g., peer to peer) where neither component has a priority (e.g., sharing an equal priority) or neither component has predetermined operations that must be performed (e.g., the predetermined operations may have shared or the duty to perform may be shared). However, in some arrangements one of the devices (e.g., the device 110) may be a primary device and the other one of the devices (e.g., the device 120) may be a secondary device. In some example embodiments, the primary/secondary relationship may be dynamically set. Furthermore, the arrangement 100 including the devices 110 and 120 may also include further devices, e.g., the arrangement 100 is not limited to two devices as will be shown by various examples described herein.

The devices 110 and 120 may be any electronic device capable of establishing a short-range communication link. For example, the devices 110 and 120 may be a mobile device (e.g., a mobile computing device, a mobile phone, a tablet computer, a personal computer, a VoIP telephone, a personal digital assistant, a wearable, a peripheral, an earpiece, a headset, headphones, an Internet of Things (IoT) device, etc.) or a stationary device (e.g., a desktop terminal, a server, an IoT device, etc.). The example embodiments may be used to establish a short-range communication link between any type(s) of device(s).

In establishing the short-range communications link, the devices 110 and 120 may include the necessary hardware, software, and/or firmware to perform conventional operations as well as operations according to the example embodiments.

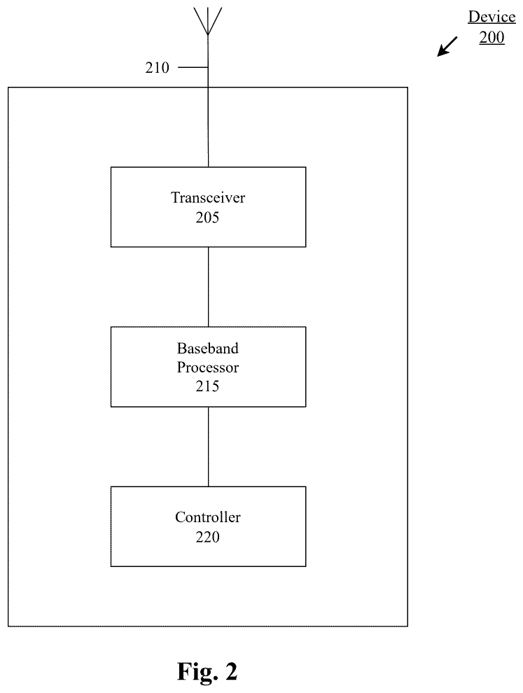

FIG. 2 shows a device 200 for establishing a short-range communication link according to various example embodiments. The device 200 may represent any of the devices 110 or 120. Specifically, the device 200 may represent the components that may be included to perform the operations according to the example embodiments.

The device 200 may include a transceiver 205 connected to an antenna 210, a baseband processor 215, and a controller 220, as well as other components (not shown). The other components may include, for example, a memory, an application processor, a battery, ports to electrically connect the device 200 to other electronic devices, etc. The transceiver 205 may be configured to exchange data over one or more connections. Specifically, the transceiver 205 may enable a short-range communication link to be established using frequencies or channels associated with the short-range communication protocol (e.g., the channels associated with a Bluetooth or UWB connection). The controller 220 may control the communication functions of the transceiver 205 and the baseband processor 215. In addition, the controller 220 may also control non-communication functions related to the other components, such as the memory, the battery, etc. Accordingly, the controller 220 may perform operations associated with an applications processor. The transceiver 205 includes circuitry configured to transmit and/or receive signals (e.g., control signals, data signals). Such signals may be encoded with information implementing any one of the methods described herein. The baseband processor 215 and the controller 220 may be operably coupled to the transceiver 205 and configured to receive from and/or transmit signals to the transceiver 255. The baseband processor 215 and the controller 220 may be configured to encode and/or decode signals for implementing any one of the methods described herein. In some embodiments, such as where the device 200 is a headset, there may be a wireless transceiver 205 on each corner of the device.

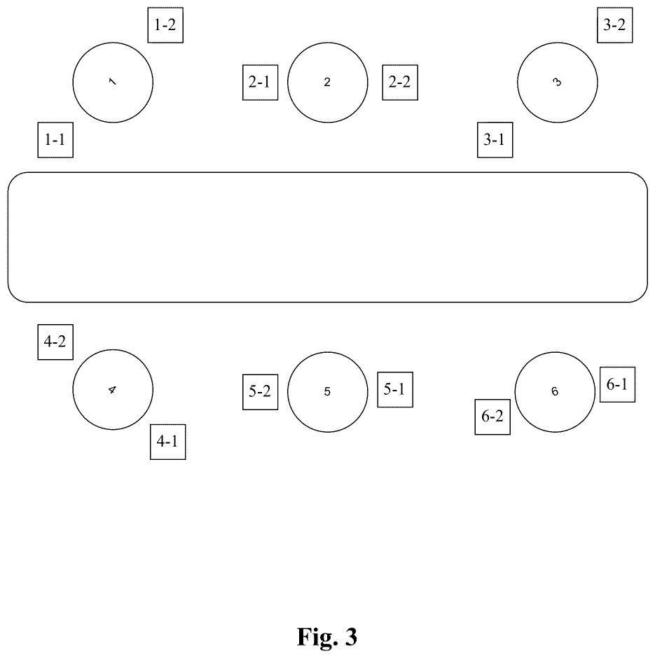

The baseband processor 215 and the controller 220 may be one or more integrated circuits (e.g., chip(s)) compatible with a wireless communication standard, such as UWB. The baseband processor 215 and the controller 220 may be configured to execute a plurality of operations of the device 200. For example, the operations may include the methods and operations related to the OOB exchange or OTA exchange of connection related information to establish a sort-range communication link.

Where FIG. 1 above discloses communications between two communication devices, in certain situations, there may be situations where a larger number of devices (e.g., three up to twenty or more), are located within a short range. FIG. 3 shows an alternative arrangement of components utilizing short-range communication links according to various example embodiments. In FIG. 3, there are six users and/or devices, although there may be more or less users and/or devices in various embodiments. In some example embodiments, as seen in FIG. 3, the communication device for each user may be paired devices (such as earpieces, a headset, or headphones) that include two audio components that have a wired or a wireless connection. For example, in FIG. 3, there are six users 1-6, each with a right paired device (e.g., 1-1-6-1) and a left paired device (1-2-6-2). Each of the devices in FIG. 3 may be interconnected in the general case; i.e., the network topology may be considered a mesh and each device may be considered a node in the mesh.

Compared to the situation where the user or device has a single physical housing (see FIG. 1), the number of active radios in a group-of-users topology is halved compared to a network where each user has paired devices like in FIG. 3. In other example embodiments, a device could have single transceiver but two or more antennas at different spatial locations to provide antenna/spatial diversity.

Referring back to FIG. 3, multiple paths may exist to route audio or other data from one node to any other node if the system supports two (or more) hops. Redundancy of routing paths may be exploited to overcome a failure along a given direct path. The topology may be used to relay, audio, haptic, or other generic data may be relayed from one user to another using UWB, Bluetooth, or other short-range wireless protocols.

In certain situations, some device to device wireless transmissions may not work reliably. If the users are located in a noisy environment, e.g., RF noise, it may be difficult to quickly and efficiently relay the audio. In addition, because the short-range wireless protocols are generally low power, there may be weak radio links, which adds to latency. These factors may result in a poor user experience when at least one of the wireless communication devices is unable to produce the proper output or where latency negatively affects the user experience. To prevent audio glitches, a device may retransmit its own data, and/or may relay data that has been received from another node or nodes.

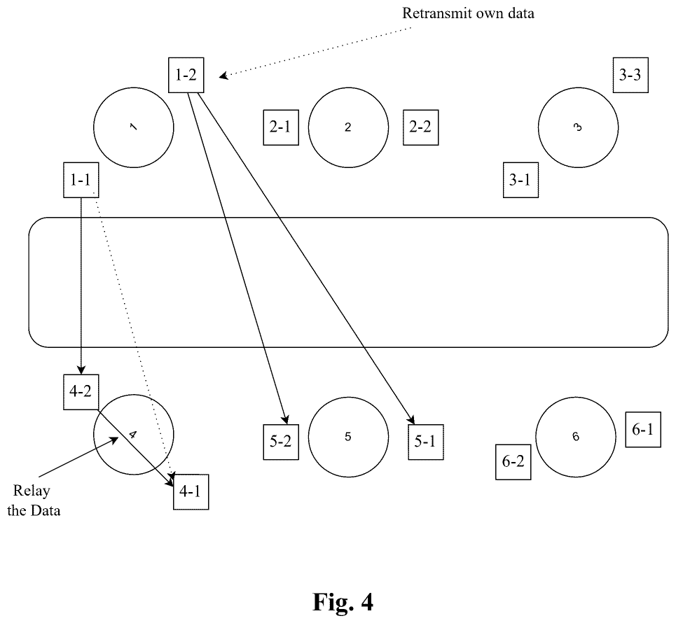

FIG. 4 shows an arrangement of components utilizing short-range communication links for retransmission or relay of data according to various example embodiments. FIG. 4 is similar to FIG. 3, but with one or more of the communication devices in FIG. 4 relaying audio or other data it receives from a device in the mesh network to another device in the network, or retransmitting its own audio or other data to another device in the network. For example, in FIG. 4, the right paired device 4-1 of user 4 may be occluded or blocked from the right paired device 1-1 of user 1 and may not be able to reliably receive data from the right paired device 1-1 of user 1. However, if the left pair paired device 4-2 of user 4 is not occluded or blocked from the right paired device 1-1 of user 1, it may receive data from the right paired device 1-1 of user 1. Thus, the left paired device 4-2 of user 4 may relay the data it has received from the right paired device 1-1 of user 1 to the right paired device 4-1 of user 4. In addition, in FIG. 4, the left paired device 1-2 of user 1 may be retransmitting its own data to both the right and left paired devices 5-1 and 5-2 of user 5.

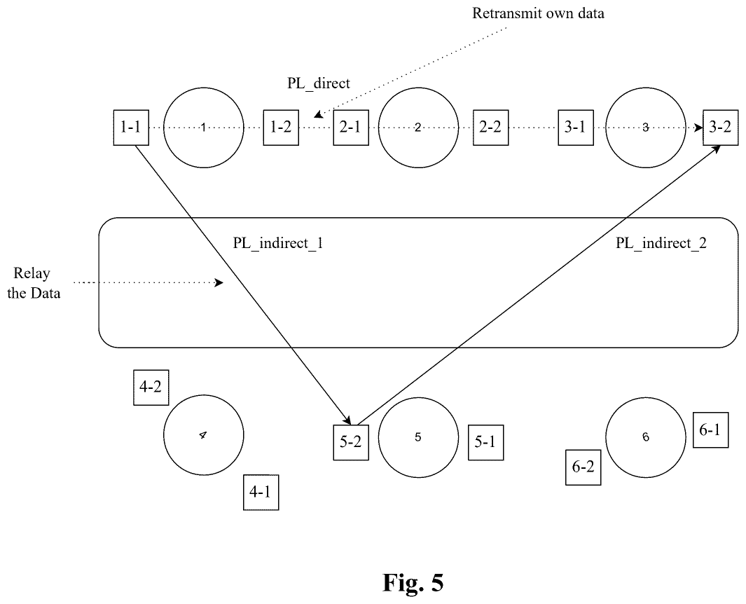

In some example embodiments, to transmit data wirelessly from one device of a user to another device of a different user in the mesh network, retransmission may be used to mitigate a low signal-to-noise ratio of a particular path. However, there may be some cases where retransmission of this type may not be sufficient to close the link for some device-to-device links due to link conditions. This may be common with RF devices and may be particularly true in UWB environments due to the low transmission power limits of UWB. In these situations, relaying data with the aid of other close by devices of other users may be performed. FIG. 5 shows such a situation.

FIG. 5 shows an alternate arrangement of components utilizing short-range communication links for retransmission or relay according to various example embodiments. In FIG. 5, the left paired device 3-2 of user 3 is occluded, blocked, or otherwise unable to easily receive data from the right paired device 1-1 of user 1. In this situation, the left paired device 5-2 of user 5 may receive the data from the right paired device 1-1 of user 1 and may relay the data to the left paired device 3-2 of user 3.

Latency requirements or preferences may vary depending on the topology of the mesh network (e.g., the number of users/devices/nodes and the relative distance between such users/devices/nodes). For example, referring back to FIG. 4, the latency requirement between user 1 and user 4 when there is a direct line of sight and are in relatively close proximity may be on the order of ten milliseconds (10 ms). However, when there is physical occlusion and/or a relatively larger distance between users like the situation in FIG. 5 with users 1 and 4, the latency requirement could be higher, for example up to almost 100 ms. Note the speed of sound is about 0.34 meters per second (m/sec), so humans are accustomed to latency increasing as distance increases. But the primary factor that allows latency to be relaxed as distance increases are the acoustic attenuation of sound and the decrease in “intimacy caused by close proximity.” Thus, there may be permissibility to relax latency with distance as acoustic attenuation matters more than propagation time. For example, in a very short path, there may be −3 dB in sound level and +1 msec latency, whereas in a longer path, there may be −12 dB in sound level and +7 msec latency. Typically, a user may perceive a 12 dB difference in sound level more readily than a 6 msec difference in latency but both may cause issues.

Typically, latencies of between 10 ms and 40 ms are satisfactory, depending on the distance between users or devices. Usually, latencies of up to 20 ms are acceptable regardless of distance between the source and the receiver.

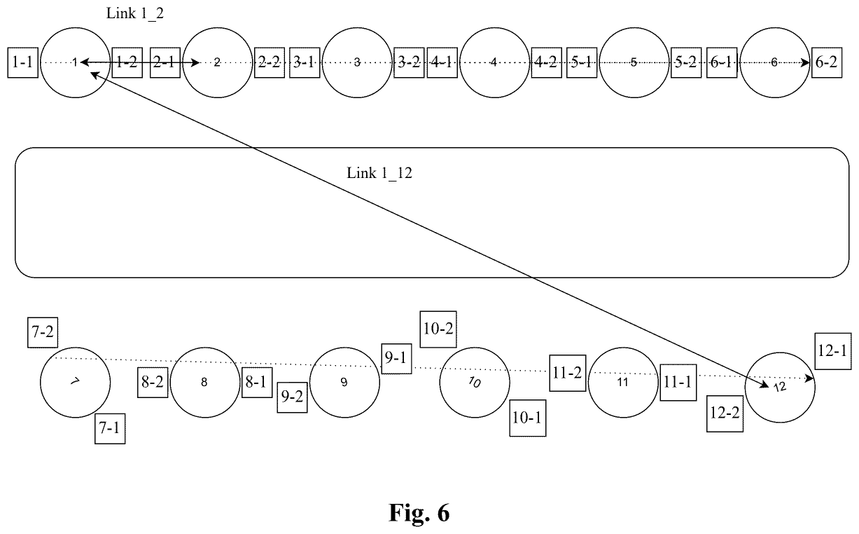

Latencies approaching 25 to 30 ms may still be acceptable to the typical user if the user is further away from the source, for example, on the order of fifteen (15) feet. Once latencies approach 100 ms, users may be bothered even if they are further away from the source. This may be seen in FIG. 6.

FIG. 6 shows an arrangement of components utilizing short-range communication links that illustrates how latency requirements depend on distance according to various example embodiments. For example, FIG. 6 shows twelve users 1-12, each user having a paired set of communication devices 1-1 though 12-2. In an example embodiment, the twelve users may be seated around a long conference table or set of tables, where user 12 may be up to forty (40) feet away from user 1. If a person is 40 feet away, then sound would naturally travel in approximately 40 ms. Thus, in some example embodiments, the latency requirement for that link (e.g., Link 1_12) would be no less than 40 ms. In any event, due to the much shorter distance between user 1 and user 2 in FIG. 6, the latency requirement for Link 1_2 may be much lower than the latency requirement for Link 1_12.

Thus, according to some example embodiments, mesh network routing assignments may be based on acoustic propagation assessments. For example, UWB radio provides a communication channel that may operate in unlicensed spectrum and delivers data streams with low latency and low power while avoiding the Industrial/Scientific/Medical (ISM) bands which are heavily utilized by Wi-Fi and Bluetooth. Thus, UWB may be an attractive technology for a consumer product to support real-time data communication among a group of nodes within a short range of each other. One downside of UWB is the maximum transmission power (regulatory limit) which causes the link budget to be substantially challenged. For example, a group of devices in a busy restaurant may have some good links and some bad links as the devices move around within the environment, go in and out of line-of-sight, change distance, etc. Accordingly, a communication system among all the nodes may break down unless the system may leverage path diversity in the form of a mesh relay network. Inserting relay hops in a path from transmitter to receiver fundamentally increases the latency of payload delivery. For a network in which low latency is a key aspect of the user experience, the usage of relay hops may degrade the experience.

However, if the network is carrying audio payloads (particularly live audio such as speech among users in a noisy environment), the acoustic propagation distances among users is on the order of five (5) to fifty (50) ms, and the acoustic attenuation from a talker's mouth to a given listener's ears is on the order of ten (10) to fifty (50) dB. Thus, the UWB communication network may serve this application very well if the acoustic propagation properties among the various users are considered when the UWB network determines its routing and audio encoding assignments.

For example, if a person is listening to a talker from a meter away, they will receive a strong acoustic signal with about 3 msec latency. If another person is listening to the same talker from the opposite end of a large table (e.g., about four meters away), the acoustic signal they receive will have lower amplitude and will arrive about 12 msec after it leaves the talker's mouth. The distant listener will be more tolerant to latency than the near-field listener. Also, the distant listener would receive the acoustic signal with lower amplitude (or greater attenuation) and more reflected energy compared to the near-field listener who get “bombarded” by the direct acoustic path from short range. It is common for a listener at just 1 meter away to have great difficulty deciphering speech from a talker in a noisy environment (e.g., audible noise) such as a bar, party, or lively restaurant. If the system monitors background noise level and spectrum, as well as the speaking level of a talker (captured by a microphone near the mouth), it may calculate the expected acoustic signal to noise ratio (SNR) for a listener at a given distance, and then decide how to best use the wireless delivery network to increase the overall SNR received by the listener. In summary, by including knowledge about acoustic propagation in determining how the wireless network encodes and routes audio payloads from each source to each listener, the system may be optimized to deliver the best user experience while keeping the loading of the wireless channel to a minimum.

The example embodiments include an improved method of communicating data among nodes in a network. There may be a large number of nodes in a network, such as a mesh topology network. Each node may be a source node (first node). Each node may also be a receiver node. Further, each node in the network may act as a relay to receive data from a source node and relay the data to one or more receiver nodes. In some example embodiments, a first node may determine that data with a latency requirement is to be sent to the one or more receiver nodes in the network. The first or source node may transmit or retransmit its own data or it may be acting as a relay to transmit data. The first node may use acoustic channel assessment techniques to estimate the latency for one or more of the possible paths it is capable of using to transmit the data to one or more receiver nodes. In particular, the first node may select a route for transmitting the data with the latency requirement to the one or more receiver nodes from among a plurality of possible routes. The selection may be based on estimating a latency for one or more of the possible routes and using the estimated latency at least in part to select the route. Once a route is determined, the data may be transmitted using the selected route.

In a typical prior art mesh network, an RF channel assessment may be done for all paths in the mesh network and data may be routed or relayed from one node to another based on the relative strength of the path as measured by typical RF channel assessment metrics like packet error rate or received signal strength indication (RSSI). In the example embodiments described herein where the acoustic propagation assessments are considered, an adaptive routing method may be employed. An acoustic channel assessment may be done for some or all of the paths in the mesh network. In some example embodiments, the acoustic channel assessment may be derived from various sensors including microphones, cameras, Inertial Measurement Units (IMU), and UWB Time of Flight (ToF) sensing, image processors, motion processors, and the like. Factors considered in the acoustic channel assessment may include a distance between the source and the receiver, a degree of occlusion, a source signal amplitude, a source signal spectrum, a source signal directivity, a background noise amplitude, a background noise spectrum, etc. In the example embodiments, it is described that one node may relay data to another node. The example embodiments may also apply to scenarios where more than one node relays the same data from a given user.

In some example embodiments, the topology of the mesh network may help to determine the latency. For example, some wireless technologies may offer location capabilities where topology may be gathered from wireless sensing, wireless ranging, and/or Angle of Arrival (AoA) measurements. One such technology is UWB. Other wireless technologies like BT or Wi-Fi/GPS may also be used for ranging/localization with varying accuracies. Acoustic sensing may also be used for determining device locations and physical topology. For example, it may be easier to extract and analyze an acoustic signal if an electronic copy of the same signal is delivered at the speed of light by radio technology. One example is that two microphones separated by distance may be used to calculate AoA.

In some example embodiments, an adaptive routing algorithm may be updated periodically in “quasi real time” to accommodate nodes moving around. The adaptive routing algorithm may assign route paths and/or encoding instructions to each transmit node, for each of its receiver nodes. The adaptive routing algorithm may prioritize delivery parameters of payload based on acoustic assessment data, such as a given latency or a maximum latency, a data rate, and a data fidelity. The adaptive routing algorithm may accommodate hidden nodes in the RF domain (e.g., by using a stronger RF channel to exchange assessment data among all nodes). The routing algorithm may run in the “control plane” while data payloads run in the “data plane.” For example, the control plane may use Bluetooth and the data plane may use UWB.

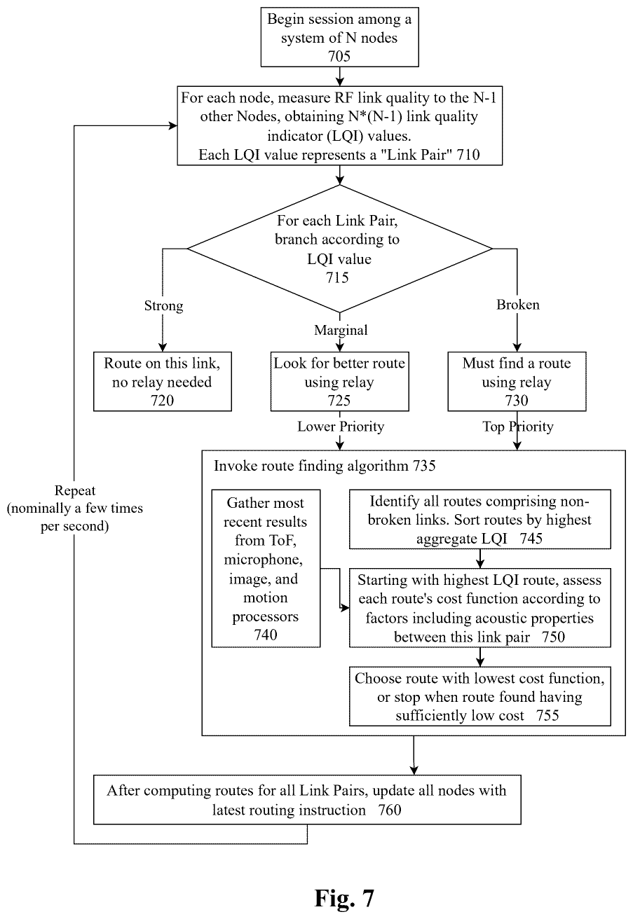

FIG. 7 shows an example flow diagram of an example adaptive routing method 700 for communicating data between nodes in a network that takes acoustic propagation assessments into account according to various example embodiments. In this example, a network or system may have N number of nodes. In some example embodiments, the network may be a mesh network like those previously discussed. A communication session among the system or network of N nodes begins at 705.

For each node, an RF link quality is measured for each link between that node and the N-1 other nodes to obtain N*(N-1) link quality indicator (LQI) values (710). Each LQI value represents a “Link Pair.” Note that link pairs may have identical LQI in each direction, allowing this algorithm to iterate half as many times as shown in FIG. 7. For each link pair, the LQI value is used to classify the strength of the link (715). If the LQI value is high (e.g., above a first threshold), then the link is classified as being strong and the data may be routed on this link without any relay being needed (720). If the LQI value is marginal (e.g., below the first threshold but above a second threshold), then the link is classified as being marginal and the node will look for a better route using another node as a relay (725). If the LQI value is low (e.g., below the second threshold), then the link is classified as being broken and the node must find a route using another node as a relay (730). The broken link takes top priority, with the marginal link and associated looking for a better route taking a lower priority.

For the broken link, an adaptive route finding algorithm may be invoked (735). The most recent data about the nodes in the network is gathered. This may include gathering acoustic channel assessment data derived from various sensors including microphones, cameras, Inertial Measurement Units (IMU), and UWB Time of Flight (ToF) sensing, image processors, motion processors, and other devices (740). All routes comprising non-broken links are identified and sorted by the highest aggregate LQI (745). Starting with the highest LQI route, the cost function of each route is assessed according to factors including acoustic properties between the link pair (750). A route is then chosen (755). The route with the lowest cost function may be chosen, or the first route found having a sufficiently low cost may be chosen.

The cost function of the route may be based on one or more of various factors, such as relay latency, distance between the source and receiver, a degree of occlusion between the source and receiver, a masking factor, a power factor, a prediction factor, and an availability factor.

In some example embodiments, the cost factor may be shown by Cost=W1*RelayLatency+W2*DistanceFactor+W3*OcclusionFactor+W4*MaskingFactor+W5*PowerFactor+W6*PredictionFactor+W7*AvailabilityFactor, where Wn is a weight for each factor. Although this example cost factor is shown as a weighted sum for simplicity, it may be a more complex function. Each term may have a weight and a “factor” that is determined by sensors and instrumentation as described elsewhere in the disclosure.

Relay latency may be a function of packet transmission ordering and re-transmission schedule, in addition to hop count. Distance, occlusion, and masking are primary factors that determine the sensitivity to latency for a given Link Pair. Each factor gets smaller as distance, occlusion, and masking increase, respectively. With respect to the power factor, if a given node has a low battery or a more power-hungry radio, this factor may increase. The prediction factor may be useful where motion sensing may determine whether nodes are moving apart or moving closer together. Availability relates to whether a node that is a candidate for a relay is busy or booked. If a candidate relay node is booked up relaying other traffic, it will have a higher cost.

Referring back to FIG. 7, once a route has been found for any broken nodes, the adaptive route finding algorithm may be invoked to try to find better nodes for each of the marginal links. After computing routes for all Link Pairs, all nodes are updated with the latest routing instructions (760). The process (710-760) may be repeated as necessary, nominally a few times per second.

In some example embodiments, the latency requirement may depend on the data being transmitted. For a given topology, data type could also dictate the latency requirements. For example, audio data may have a different latency requirement than haptics, which may have a lower bandwidth. In some example embodiments, for an immersive experience, sound may come at a given time, whereas haptics may come at a different time. Other data latency requirement may be different than the one required for audio/haptics.

Latency requirements may also change over time or from user to user. If the latency requirement changes for a user and data type, then the transition may be done smoothly so it is not perceived as an unwanted artifact. In some example embodiments, if a latency requirement for audio changes, then a jitter buffer may be manipulated to change the latency smoothly.

Variable latency may help with wireless transmission. If it is known that some links do not require stringent latencies, the retrial/relay mechanisms may be optimized to minimize air time and/or power consumption.

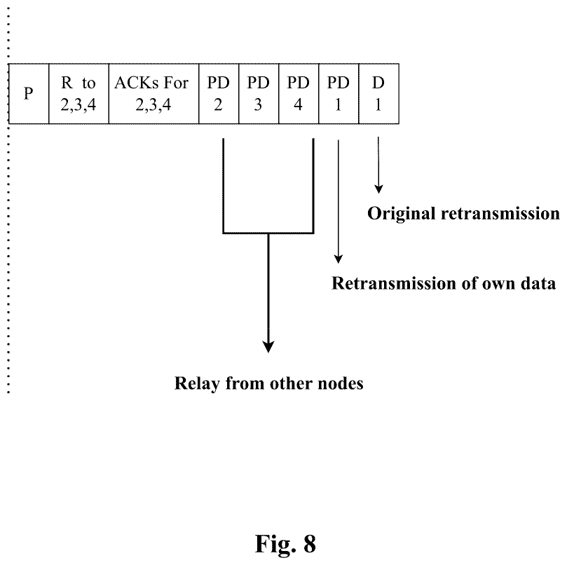

In a low latency network, for a direct voice link, a multicast timeline may be used. FIG. 8 shows an example payload for audio or voice data in a low latency network according to various example embodiments. The payload may include data 1 to be transmitted, retransmission of own data, relayed data from other nodes, acknowledgments of the relayed data, ranging data, and a preamble. To do retransmission of its own audio stream, Data 1 needs to include previous packets. When there is a retransmission, previous and current packets could be downsampled or otherwise compressed to reduce the airtime these payloads consume. In order to relay payloads from other nodes, data 1 needs to include all recently received audio payloads from all other nodes. The packet structure shown in FIG. 8 is only one example of a packet structure that may be used to convey relay data and retransmission data. Other packet structures may also be used.

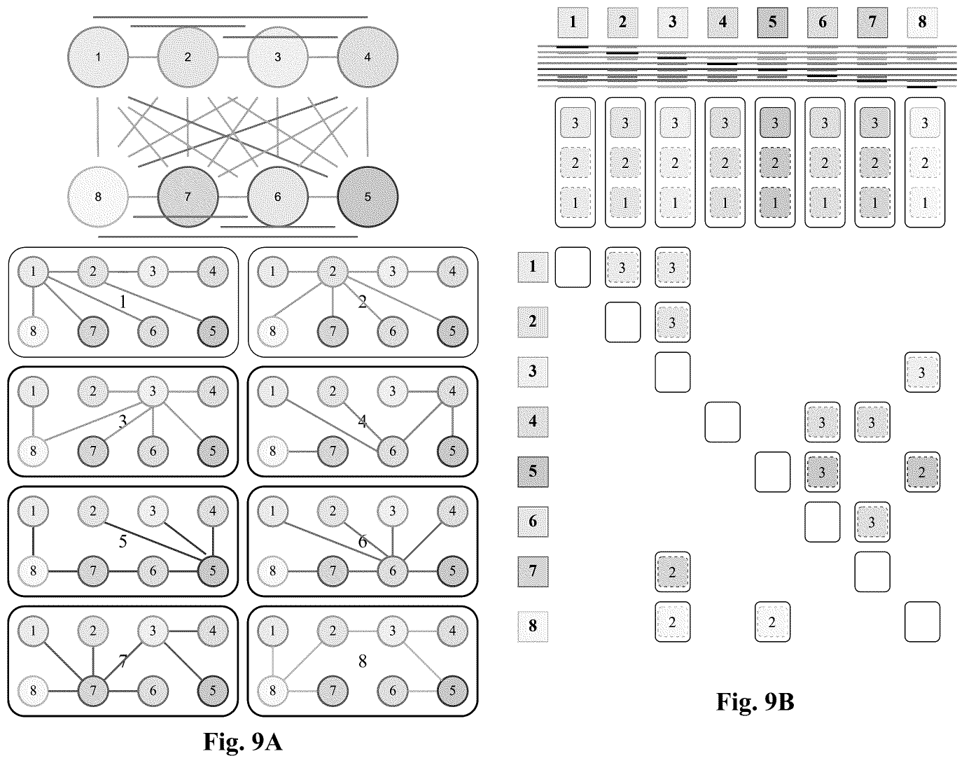

An example of a selective relay mechanism is shown in FIGS. 9A and 9B. FIGS. 9A and 9B show an example selective relay map for a low latency network according to various example embodiments. FIG. 9A shows many possible routes that a payload might be available to get from any source to any sink. FIGS. 9A and 9B show eight users/devices/nodes, although there may be a different number of users/devices/nodes in other embodiments. In FIG. 9B, for each payload, the number it shows denotes the sequence number that the payload belongs to (3 being the most current payload). The transport window for each user for their own transmissions have been shown as a rectangle of size 3 encompassing the payload at different times. Selectively relayed packets are shown in the right bottom of FIG. 9B.

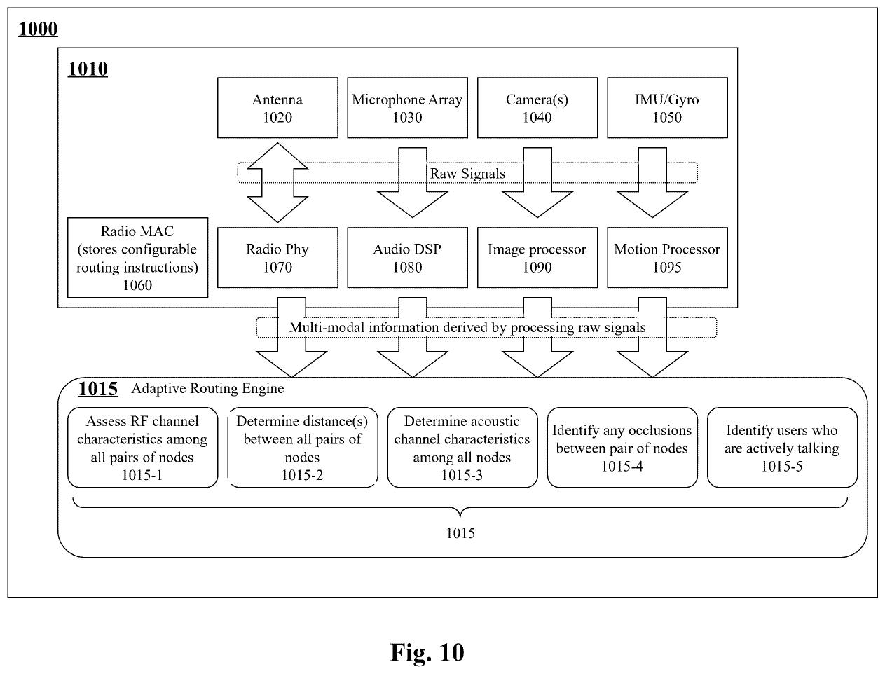

FIG. 10 shows an example node for communicating via short-range communication links with other nodes using an adaptive routing scheme according to various example embodiments. FIG. 10 shows a node 1000 that has a hardware portion 1010 and a software portion 1015 for performing the methods and techniques described herein. The node 1000 may be similar to devices 110 and 120 in FIG. 1 and/or may be similar to device 200 in FIG. 2. The node 1000 is for establishing a short-range communication link according to various example embodiments. The node 1000 may represent the components that may be included to perform the operations described herein with respect to finding routes based on acoustic propagation assessments. The node 1000 may be any electronic device capable of establishing a short-range communication link. For example, the node 1000 may be a mobile device (e.g., a mobile computing device, a mobile phone, a tablet computer, a personal computer, a VoIP telephone, a personal digital assistant, a wearable, a peripheral, an earpiece, a headset, headphones, an Internet of Things (IoT) device, etc.) or a stationary device (e.g., a desktop terminal, a server, an IoT device, etc.).

The hardware portion 1010 of node 1000 may include or more of an antenna 1020, a microphone or microphone array 1030, one or more cameras 1040, an IMU/gyroscope 1050, a radio MAC 1060 (for storing configurable routing instructions), a radio physical (PHY) layer 1070, an audio digital signal processor (DSP) 1080, an image processor 1090, and a motion processor 1095. The antenna 1020 provides and receives raw signals to and from the radio PHY layer 1070. The microphone or microphone array 1030, the camera(s) 1040, and the IMU/gyroscope 1050 provide raw signals to the audio DSP 1080, the image processor 1090, and the motion processor 1095, respectively. The radio PHY layer 1070, the audio DSP 1080, the image processor 1090, and the motion processor 1095 process these raw signals and provide multi-modal information to the software portion 1015 of the node 1000.

The software portion 1015 of the node 1000 includes an adaptive routing engine that comprises one or more engines for performing the steps of the adaptive routing method described herein. For example, there may be an engine that assesses RF channel characteristics among all pairs of nodes (1015-1), an engine that determines a distance(s) between all pairs of nodes (1015-2), an engine that determines acoustic channel characteristics among all nodes (1015-3), an engine that identifies any occlusions between pairs of nodes (1015-4), and/or an engine that identifies users who are actively talking (1015-5). Although FIG. 10 shows engines 1015-1 through 1015-5 being separate engines, they could be combined into one or more engine.

Together, the engines 1015 determine characteristics of connectedness among users within a system and compute routing instructions for voice packets based on some or all of the following: 1) Degree of RF couplings among nodes; 2) Degree of acoustic coupling between nodes; and 3) Other factors that relate to system cost, such as power. The engines 1015 deliver the routing instructions to the Radio MAC blocks (1060) in each hardware node. Although FIG. 10 shows the software functionality on a particular node, the software functionality of engines 1015 may run on any host in the system or be distributed among participating nodes in the system.

The above described engines 1015 each being an application (e.g., a program) executed by a processor (such as a processor similar to baseband processor 215 in FIG. 2) is only an example. The functionality associated with the engines 1015 may also be represented as a separate incorporated component of the node 1000 or another node in the system (or the devices 110 and 120 in FIG. 1) or may be a modular component coupled to the node 1000 or the device 110 or device 120 of FIG. 1, e.g., an integrated circuit with or without firmware. For example, the integrated circuit may include input circuitry to receive signals and processing circuitry to process the signals and other information. The engines may also be embodied as one application or separate applications or as part of one or more multifunctional programs. Accordingly, the applications may be implemented in a variety of manners in hardware, software, firmware, or a combination thereof. In addition, in some devices, the functionality described for the processor 215 may be split among two or more processors such as a baseband processor and an applications processor. The example embodiments may be implemented in any of these or other configurations of a device.

### EXAMPLES

In a first example, a method, comprising determining, by a first node of a network comprising a plurality of nodes, data with a latency requirement is to be sent to one or more receiver nodes in the network, selecting, from among a plurality of possible routes, a route for transmitting the data with the latency requirement to the one or more receiver nodes, wherein selecting the route comprises estimating a latency for one or more of the possible routes and using the estimated latency at least in part to select the route and transmitting the data with the latency requirement to the one or more receiver nodes using the selected route.

In a second example, the method of the first example, wherein the data with the latency requirement comprises one of audio data or haptic data, and wherein the selecting of the route is dependent on a type of the data.

In a third example, the method of the first example, wherein the data with the latency requirement comprises retransmitted data or received data that is to be relayed to the one or more receiver nodes.

In a fourth example, the method of the first example, wherein the estimating of the latency comprises considering one or more of: a type of the data; an amount of occlusion between the first node and the one or more receiver nodes; or a distance between the first node and the one or more receiver nodes.

In a fifth example, the method of the fourth example, further comprising calculating the amount of occlusion or the distance based on a topology of the network derived from one or more prior wireless transmissions in the network.

In a sixth example, the method of the fifth example, wherein the network comprises an ultra-wideband (UWB) network, and wherein the method further comprises deriving the topology of the UWB network from a location capability selected from one or more of wireless sensing, wireless ranging, or Angle of Arrival (AoA) measurement.

In a seventh example, the method of the first example, further comprising adjusting the route for transmitting the data when the latency requirement changes.

In an eighth example, the method of the first example, further comprising selecting a subset of the plurality of nodes to relay data for a particular node of the plurality of nodes based on the estimated latency.

In a ninth example, the method of the first example, wherein the estimating the latency comprises performing an acoustic channel assessment.

In a tenth example, the method of the ninth example, wherein performing the acoustic channel assessment further comprises gathering information from one or more sensors or devices associated with one or more nodes, the one or more sensors or devices comprising one or more of: a microphone; a camera; an Inertial Measurement Unit (IMUs); a UWB Time of Flight (ToF) sensor; an image processor; or a motion processor.

In an eleventh example, the method of the ninth example, wherein performing the acoustic channel assessment further comprises determining one or more of: a distance between the first node and the one or more receiver nodes; a degree of occlusion between the first node and the one or more receiver nodes; a source signal amplitude; a source signal spectrum; a source signal directivity; a background noise amplitude; or a background noise spectrum.

In a twelfth example, the method of the first example, further comprising updating the estimated latency to accommodate movement of a node in the network.

In a thirteenth example, the method of the first example, wherein the estimating the latency further comprises measuring a link quality for two or more links between the first node and two or more of the plurality of nodes to obtain a plurality of link quality indicator (LQI) values.

In a fourteenth example, the method of the thirteenth example, further comprising classifying a strength of a respective link between the first node and another node of the plurality of nodes based on an LQI value for the link.

In a fifteenth example, the method of the fourteenth example, wherein the transmitting of the data to the one or more receiver nodes on the selected route includes transmitting the data using the respective link when the LQI value for the respective link is above a high threshold.

In a sixteenth example, the method of the fourteenth example, further comprising considering another route using another node as a relay to transmit the data if the LQI value for the respective link is below a high threshold but above a low threshold.

In a seventeenth example, the method of the fourteenth example, further comprising determining that the respective link is broken and selecting another route using another node as a relay when the LQI value for the respective link is below a low threshold.

In an eighteenth example, the method of the seventeenth example, wherein the finding of another route comprises identifying a plurality of non-broken links and sorting the non-broken links by an aggregate LQI value.

In a nineteenth example, the method of the eighteenth example, further comprising assessing a cost function for each of a plurality of routes, the cost function based on one or more of: a relay latency; a distance between the first node and the one or more receiver nodes; a degree of occlusion between the between the first node and the one or more receiver nodes; a masking factor; a power factor; a prediction factor; or an availability factor.

In a twentieth example, the method of the nineteenth example, wherein the selecting of the route is based at least in part on the cost function for each of the plurality of routes.

In a twenty first example, the method of the twentieth example, wherein the route with the lowest cost function is selected.

In a twenty second example, the method of the twentieth example, wherein a first route having a cost function below a predetermined threshold is selected.

In a twenty third example, a processor configured to perform any of the first through twenty second examples.

In a twenty fourth example, a wireless communication device configured to perform any of the first through twenty second examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure covers modifications and variations of this disclosure provided they come within the scope of the appended claims and their equivalent.

What is claimed is:

1. A method, comprising:
determining, by a first node of a network comprising a plurality of nodes, data with a latency requirement is to be sent to one or more receiver nodes in the network;
selecting, from among a plurality of possible routes, a route for transmitting the data with the latency requirement to the one or more receiver nodes, wherein selecting the route comprises estimating a latency for one or more of the possible routes and using the estimated latency at least in part to select the route; and
transmitting the data with the latency requirement to the one or more receiver nodes using the selected route.

2. The method of claim 1, wherein the data with the latency requirement comprises one of audio data or haptic data, and wherein the selecting of the route is dependent on a type of the data.

3. The method of claim 1, wherein the data with the latency requirement comprises retransmitted data or received data that is to be relayed to the one or more receiver nodes.

4. The method of claim 1, wherein the estimating of the latency comprises considering one or more of: a type of the data; an amount of occlusion between the first node and the one or more receiver nodes; or a distance between the first node and the one or more receiver nodes.

5. The method of claim 4, further comprising calculating the amount of occlusion or the distance based on a topology of the network derived from one or more prior wireless transmissions in the network.

6. The method of claim 5, wherein the network comprises an ultra-wideband (UWB) network, and wherein the method further comprises deriving the topology of the UWB network from a location capability selected from one or more of wireless sensing, wireless ranging, or Angle of Arrival (AoA) measurement.

7. The method of claim 1, further comprising adjusting the route for transmitting the data when the latency requirement changes.

8. The method of claim 1, further comprising selecting a subset of the plurality of nodes to relay data for a particular node of the plurality of nodes based on the estimated latency.

9. The method of claim 1, wherein the estimating the latency comprises performing an acoustic channel assessment.

10. The method of claim 9, wherein performing the acoustic channel assessment further comprises gathering information from one or more sensors or devices associated with one or more nodes, the one or more sensors or devices comprising one or more of: a microphone; a camera; an Inertial Measurement Unit (IMUs); a UWB Time of Flight (ToF) sensor; an image processor; or a motion processor.

11. The method of claim 9, wherein performing the acoustic channel assessment further comprises determining one or more of: a distance between the first node and the one or more receiver nodes; a degree of occlusion between the first node and the one or more receiver nodes; a source signal amplitude; a source signal spectrum; a source signal directivity; a background noise amplitude; or a background noise spectrum.

12. The method of claim 1, comprising updating the estimated latency to accommodate movement of a node in the network.

13. The method of claim 1, wherein the estimating the latency further comprises measuring a link quality for two or more links between the first node and two or more of the plurality of nodes to obtain a plurality of link quality indicator (LQI) values.

14. The method of claim 13, further comprising classifying a strength of a respective link between the first node and another node of the plurality of nodes based on an LQI value for the link.

15. The method of claim 14, wherein the transmitting of the data to the one or more receiver nodes on the selected route includes transmitting the data using the respective link when the LQI value for the respective link is above a high threshold.

16. The method of claim 14, further comprising determining that the respective link is broken and selecting another route using another node as a relay when the LQI value for the respective link is below a low threshold.

17. The method of claim 16, wherein the finding of another route comprises identifying a plurality of non-broken links and sorting the non-broken links by an aggregate LQI value.

18. The method of claim 17, further comprising assessing a cost function for each of a plurality of routes, the cost function based on one or more of: a relay latency; a distance between the first node and the one or more receiver nodes; a degree of occlusion between the between the first node and the one or more receiver nodes; a masking factor; a power factor; a prediction factor; or an availability factor.

19. The method of claim 18, wherein the selecting of the route is based at least in part on the cost function for each of the plurality of routes.

20. An apparatus comprising processing circuitry configured to:
determine data with a latency requirement is to be sent to a receiver node in a network comprising a plurality of nodes;
select a route for transmitting the data with the latency requirement to the receiver node from among a plurality of possible routes, wherein the route is selected, based at least on an estimated latency for one or more of the plurality of possible routes; and
prepare the data for transmission to the receiver node on the selected route.
